(19) United States
(12) Patent Application Publication
(10) Pub. No.: US 2013/0076583 A1
(43) Pub. Date: Mar. 28, 2013

(54) MULTIPLE FEED ANTENNA OPERATING AT SIGNIFICANTLY DIFFERING FREQUENCIES

(71) Applicant: Dave IREDALE, Hsinchu (TW)

(72) Inventor: Dave IREDALE, Hsinchu (TW)

(73) Assignee: MICROELECTRONICS TECHNOLOGY, INC., Hsinchu (TW)

(21) Appl. No.: 13/614,772

(22) Filed: Sep. 13, 2012

Related U.S. Application Data
(60) Provisional application No. 61/538,556, filed on Sep. 23, 2011.

(51) Int. Cl. H01Q 13/02

(52) U.S. Cl. 343/776

(57) ABSTRACT

A multiple feed antenna includes a first waveguide having a first upper aperture with a first wall surrounding the first upper aperture; a second waveguide disposed in parallel to the first waveguide, in which the second waveguide has a second upper aperture; a second wall surrounding the first wall, with a first groove between the second wall and the first wall; a third wall surrounding the second wall and the second upper aperture, with a second groove between the third wall and the second wall; a fourth wall surrounding the third wall, with a third groove between the fourth wall and the third wall; and a plurality of ribs connecting the first wall and the second wall.

### BACKGROUND

1. Technical Field

The present disclosure relates to a multiple feed antenna, and more particularly, to a multiple feed antenna operating at significantly differing frequencies.

2. Description of Related Arts

Multi-beam feed antennas were first described by Imaizumi et al in U.S. Pat. No. 6,388,633, which discloses problems associated with the reception of signals from two satellites which are closely spaced in angular terms. The close spacing of satellites means that the receiving dish has to be illuminated with two feed horns which are also closely spaced. Consequently, the feed horns of the conventional antenna cannot be used since the actual size of the horn is too large for two of them to fit physically together.

There are many types of feed horns or feed antennas used in conventional feeds on a receiving dish. However, the traditional feed horn designs are done to optimize the illumination over the receiving dish. This is usually done by having a larger aperture than the waveguide in the feed.

The advantage of the multi-beam antenna, as described in U.S. Pat. No. 6,388,633, allows for the two waveguides to be placed closely enough together to receive the signals from the two satellites, while the common wall surrounding the two feeds allows the larger aperture to provide an improved illumination on the dish.

U.S. Pat. No. 6,388,633 also describes how the invention can be adapted using different types of feed antennas such as dielectric rods (polyrods), or helical antennas as well as variations of the conventional fed horn types such as scalar ring feeds or conical feeds.

U.S. Pat. No. 6,388,633 also shows how the multi-beam antenna can be incorporated into a device with an active circuit substrate to provide signal processing and switching between the two feeds, which presents a description of the type of product as seen in some markets today. The design of the multi-beam antenna clearly demonstrates the fact that the two satellites are operating at the same (or similar) frequency bands.

U.S. Pat. No. 6,313,808 by Yuanzhu, establishes the multi-beam antenna disclosed in U.S. Pat. No. 6,388,633 by applying the concept of tilting the apertures of the two (or more) feeds towards the center line of the device to improve the performance of the multi-beam antenna. The tilting of the apertures of the feed toward the center line is done to better illuminate the center part of the dish. This leads to improved illumination performance on the dish and gives improved performance over the device proposed by Imaizumi et al.

However, industrial experience has shown that with closely spaced satellites, the benefits of tilting the apertures towards the center of the dish are very small. With larger satellite spacing, the benefits can be more significant.

### SUMMARY

One aspect of the present disclosure provides a multiple feed antenna operating at significantly differing frequencies.

A multiple feed antenna according to this aspect of the present disclosure comprises a first waveguide having a first upper aperture with a first wall surrounding the first upper aperture; a second waveguide disposed in parallel to the first waveguide, in which the second waveguide has a second upper aperture; a second wall surrounding the first wall, with a first groove between the second wall and the first wall; a third wall surrounding the second wall and the second upper aperture, with a second groove between the third wall and the second wall; a fourth wall surrounding the third wall, with a third groove between the fourth wall and the third wall; and a plurality of ribs connecting the first wall and the second wall.

In one embodiment of the present disclosure, the multiple feed antenna comprises two first waveguides, and the second waveguide is disposed between the at least two first waveguides. In one embodiment of the present disclosure, the third wall comprises at lease one non-circular groove such as an arc-shaped groove between the second upper aperture and the third groove. In one embodiment of the present disclosure, the multiple feed antenna comprises a first plate disposed in a first bottom aperture of the first waveguide, a second plate disposed in a second bottom aperture of the second waveguide, and the first plate and the second plate are disposed in a perpendicular manner. In one preferred embodiment of the present disclosure, the first plate and the second plate have a multi-step shape.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 illustrates a full view of a multiple feed antenna according to one exemplary embodiment of the present invention;

FIG. 2 illustrates a top view of the multiple feed antenna shown in FIG. 1;

FIG. 3 illustrates a cross-sectional view of the multiple feed antenna along a sectional line 1-1 in FIG. 2;

FIG. 4 illustrates a cross-sectional view of the multiple feed antenna along a sectional line 2-2 in FIG. 2;

FIG. 5 illustrates a full view of the corresponding cavity of the multiple feed antenna according to one exemplary embodiment of the present invention;

FIG. 6 illustrates a top view of the corresponding cavity of the multiple feed antenna shown in FIG. 5

FIG. 7 illustrates a cross-sectional view of the corresponding cavity of the multiple feed antenna along a sectional line 3-3 in FIG. 6;

FIG. 8 illustrates a cross-sectional view of the corresponding cavity of the multiple feed antenna along a sectional line 4-4 in FIG. 6;

FIG. 9 is a gain plot of the multiple feed antenna according to one exemplary embodiment of the present invention; and

FIG. 10 is a cross-gain plot of the multiple feed antenna according to one exemplary embodiment of the present invention.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment. References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a multiple feed antenna operating at significantly differing frequencies. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

A multiple feed antenna according to one embodiment of the present disclosure comprises a first waveguide having a first upper aperture with a first wall surrounding the first upper aperture; a second waveguide disposed in parallel to the first waveguide, in which the second waveguide has a second upper aperture; a second wall surrounding the first wall, with a first groove between the second wall and the first wall; a third wall surrounding the second wall and the second upper aperture, with a second groove between the third wall and the second wall; a fourth wall surrounding the third wall, with a third groove between the fourth wall and the third wall; and a plurality of ribs connecting the first wall and the second wall.

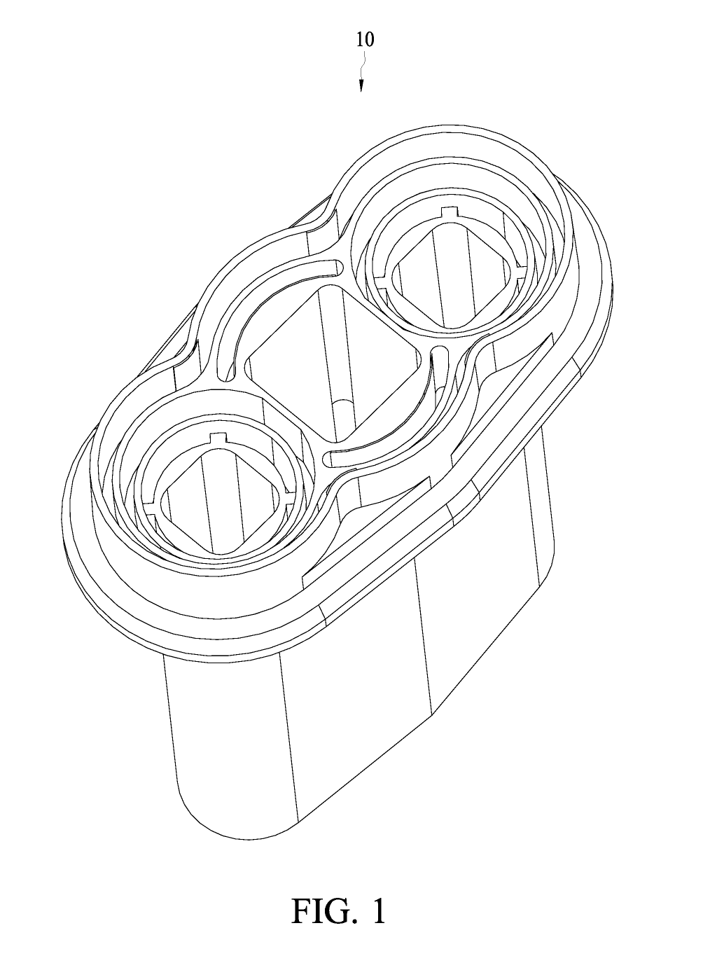

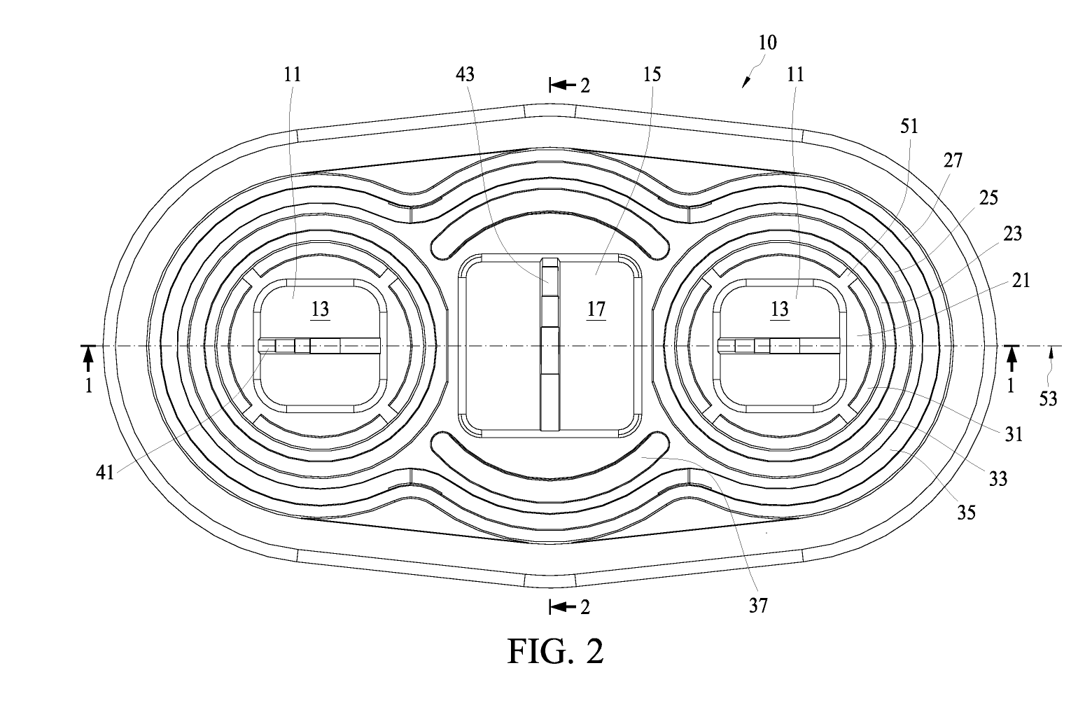

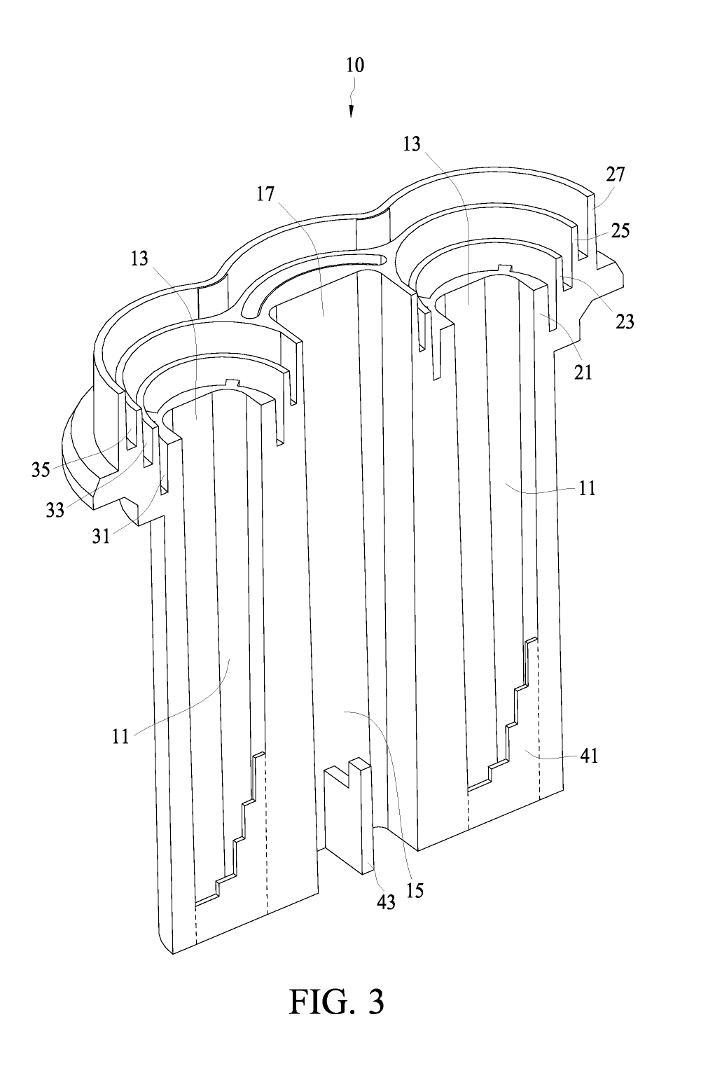

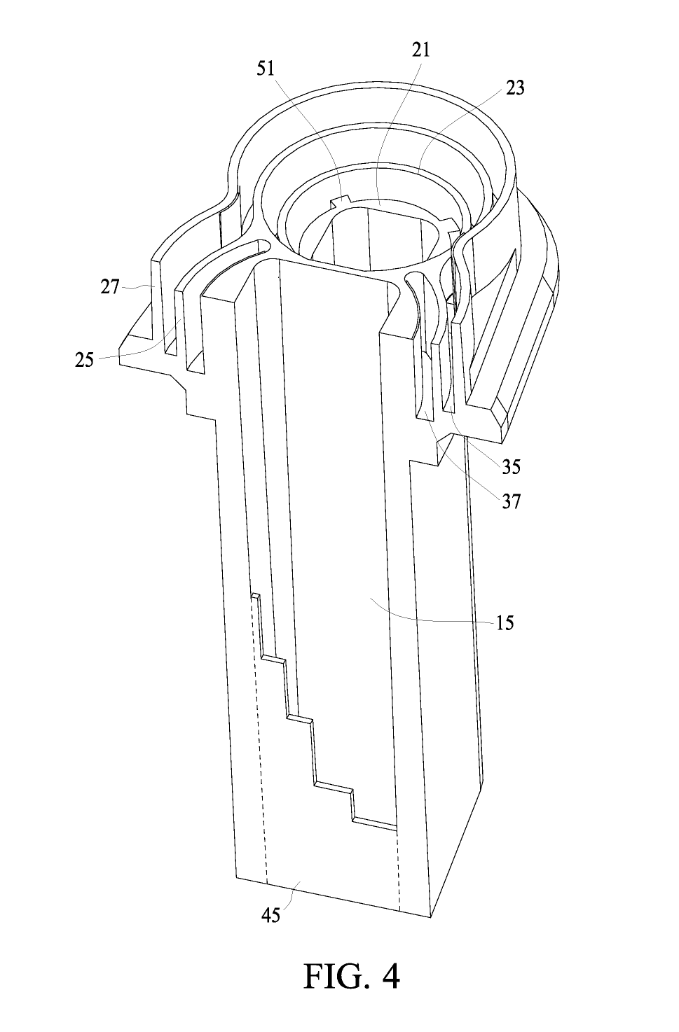

FIG. 1 illustrates a full view of a multiple feed antenna 10 according to one exemplary embodiment of the present invention. FIG. 2 illustrates a top view of the multiple feed antenna 10 shown in FIG. 1. FIG. 3 illustrates a cross-sectional view of the multiple feed antenna 10 along a sectional line 1-1 in FIG. 2, and FIG. 4 illustrates a cross-sectional view of the multiple feed antenna 10 along a sectional line 2-2 in FIG. 2.

Referring to FIG. 1 to FIG. 4, in one embodiment of the present invention, the multiple feed antenna 10 comprises two first waveguides 11 each having a first upper aperture 13, with a first wall 21 surrounding the first upper aperture 13; a second waveguide 15 disposed between the two first waveguides 11, and the second waveguide 15 having a second upper aperture 17; a second wall 23 surrounding the first wall 21, with a first groove 31 between the second wall 23 and the first wall 21; a third wall 25 surrounding the second wall 23 and the second upper aperture 17, with a second groove 33 between the third wall 25 and the second wall 23; a fourth wall 27 surrounding the third wall 25, with a third groove 35 between the fourth wall 27 and the third wall 25; and a plurality of ribs 51 connecting the first wall 21 and the second wall 23.

In one embodiment of the present invention, the third wall 25 comprises at lease one non-circular groove 37 between the second upper aperture 17 and the third groove 25. In one preferred embodiment of the present invention, the non-circular groove 37 is an arc-shaped groove, as shown in FIG. 2. In one embodiment of the present invention, the first upper aperture 13 is rectangular with round corners, and the second upper aperture 17 is also rectangular with round corners. In another embodiment of the present invention, the first upper aperture can be circular or elliptic, and the second upper aperture can be circular or elliptic, as well.

In one embodiment of the present invention, the multiple feed antenna 10 comprises a first plate 41 disposed in a first bottom aperture of the first waveguide 11. In one preferred embodiment of the present invention, the first plate 41 has a multi-step shape, as shown in FIG. 3. In one preferred embodiment of the present invention, the multiple feed antenna 10 comprises a second plate 43 disposed in a second bottom aperture of the second waveguide 15. In one preferred embodiment of the present invention, the second plate 45 has a multi-step shape, as shown in FIG. 4. In one embodiment of the present invention, the first plate 41 in the first waveguide 11 and the second plate 45 in the second waveguide 15 are disposed in a perpendicular manner, as shown in FIG. 2.

Referring to FIG. 2, In one embodiment of the present invention, the multiple feed antenna 10 comprises four ribs 51 separated by 90°. In one preferred embodiment of the present invention, the four ribs 51 are disposed at 45° relative to a horizontal line 53. In one preferred embodiment of the present invention, the rib 51 has a tapered shape with an inner curve and an outer curve, and the width of the rib 51 is preferably 4°. In addition, the four ribs 51 can be positioned at other angles to achieve similar effects.

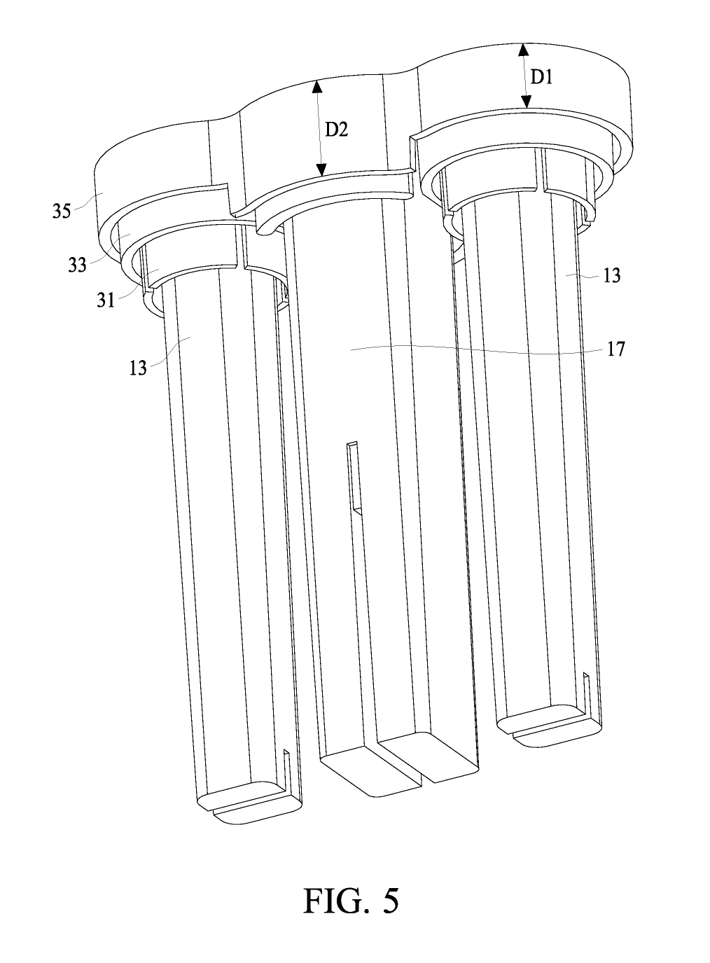

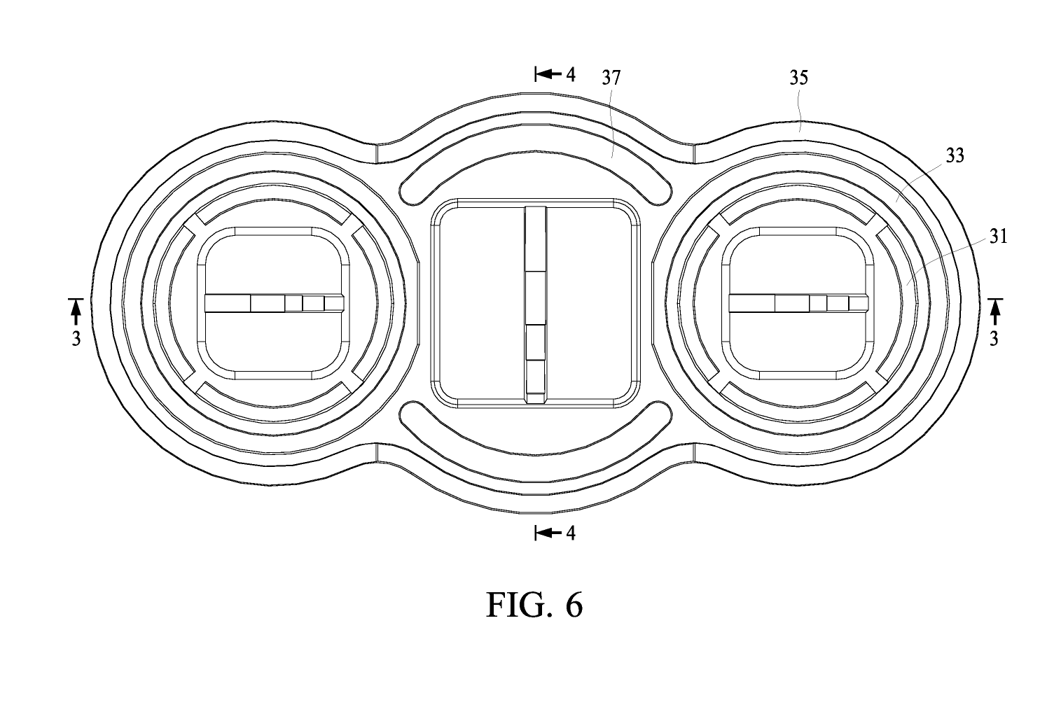

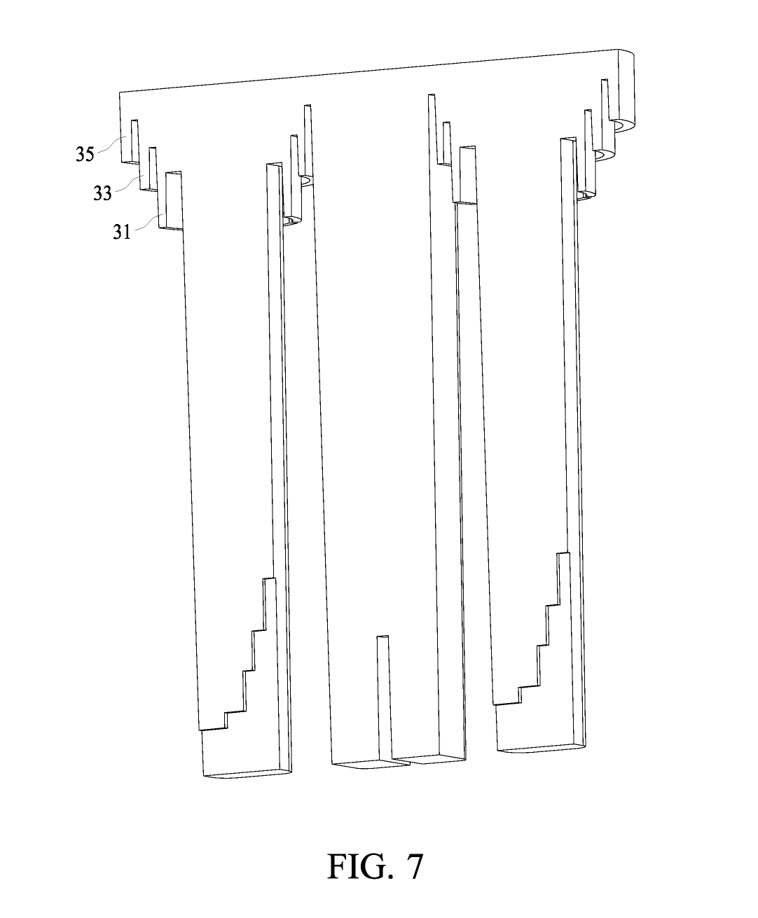

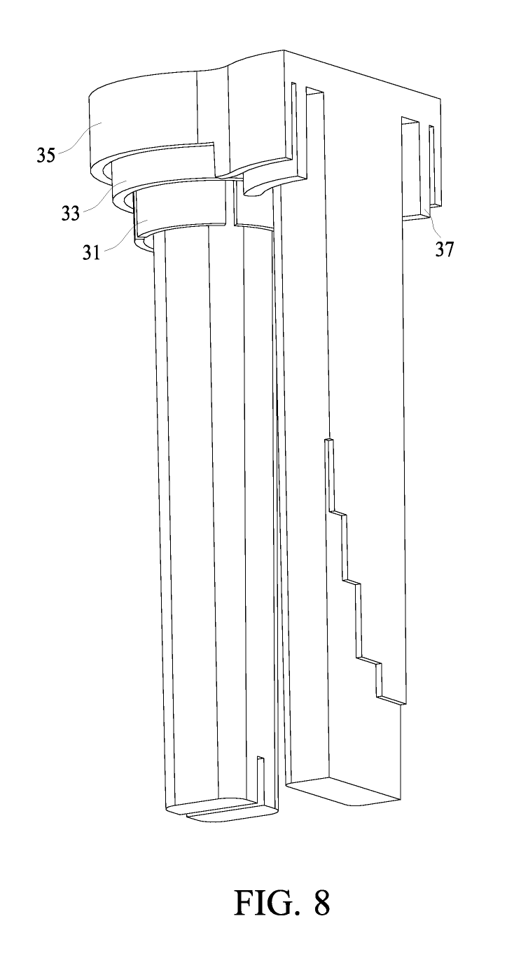

To express the structure of the first groove 31, the second groove 33, the third groove 35, and the non-circular groove 37, FIG. 5 illustrates a full view of the corresponding cavity of the multiple feed antenna 10 according to one exemplary embodiment of the present invention. FIG. 6 illustrates a top view of the corresponding cavity of the multiple feed antenna 10 shown in FIG. 5. FIG. 7 illustrates a cross-sectional view of the corresponding cavity of the multiple feed antenna 10 along a sectional line 3-3 in FIG. 6, and FIG. 8 illustrates a cross-sectional view of the corresponding cavity of the multiple feed antenna 10 along a sectional line 4-4 in FIG. 6.

As shown in FIG. 5, in one embodiment of the present invention, the third groove 35 has a first depth D1 around the first upper aperture 13, a second depth D2 around the second upper aperture 17, and the first depth D1 is smaller than the second depth D2, as shown in FIG. 5. In contrast, the depth of the first groove 31 may have a uniform depth, and the depth of the second groove 33 may have a uniform depth, as well. In particular, as the multiple feed antenna 10 operates at significantly differing frequencies, the first depth D1 can be adjusted to optimize the performance of the multiple feed antenna 10 for a higher frequency, while the second depth D2 can be adjusted to optimize the performance of the multiple feed antenna 10 for a lower frequency.

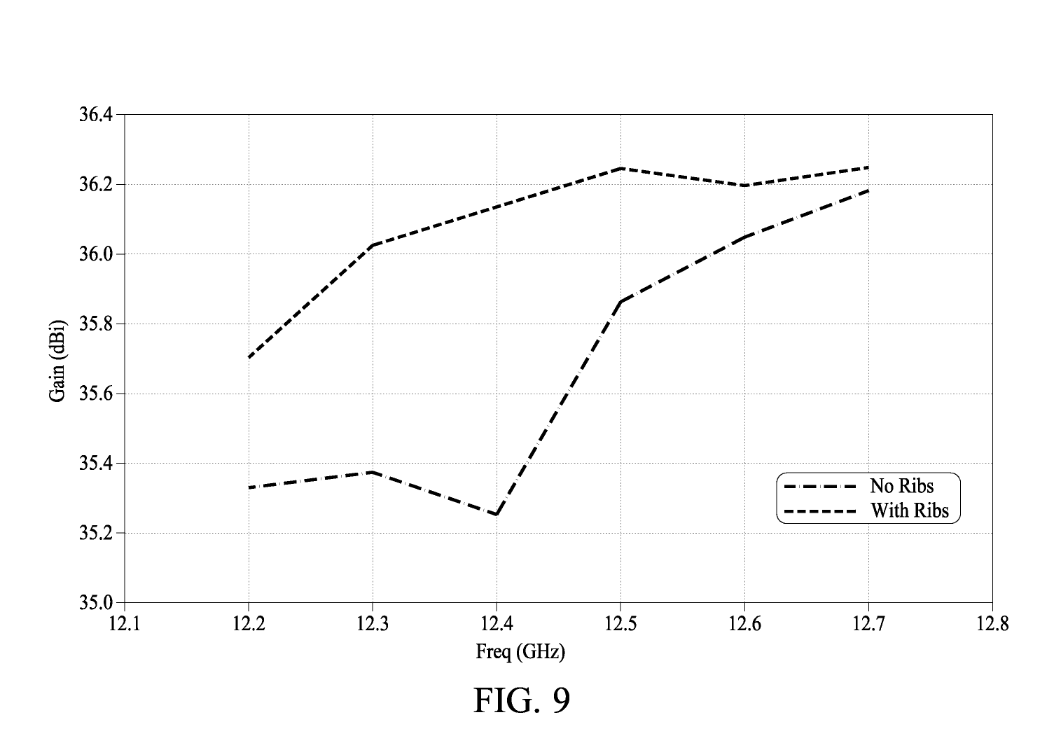

FIG. 9 is a gain plot of the multiple feed antenna 10 according to one exemplary embodiment of the present invention. The gain plot clearly demonstrates that there is a resonance in the response, causing a significant drop in gain at around 12.4 GHz without the ribs in the multiple feed antenna. In contrast, with the ribs 51 in the multiple feed antenna 10, there is no resonance in the response causing the significant drop in gain at around 12.4 GHz.

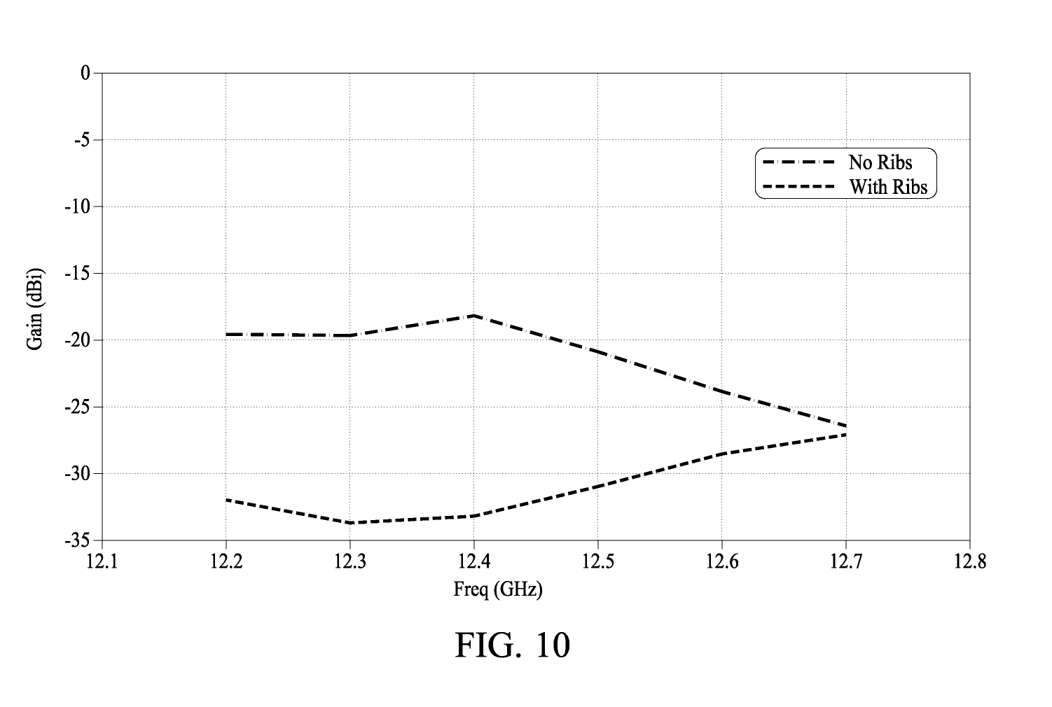

FIG. 10 is a cross-gain plot of the multiple feed antenna 10 according to one exemplary embodiment of the present invention. The cross-polar plot shows the significant difference that the incorporation of the ribs 51 has made to the bore sight cross-polar plot on the dish. The resonance that occurs within the feed when the modification has not been applied is one that excites a large cross-polar contribution in the feed aperture, which accounts for the degraded performance as seen. The incorporation of the ribs 51 in the multiple feed antenna 10 prevents this resonance to occur; therefore, the cross-polar performance is mainly determined by the polarizer performance alone.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A multiple feed antenna, comprising:
a first waveguide having a first upper aperture with a first wall surrounding the first upper aperture;
a second waveguide disposed in parallel to the first waveguide, in which the second waveguide has a second upper aperture;
a second wall surrounding the first wall, with a first groove between the second wall and the first wall;
a third wall surrounding the second wall and the second upper aperture, with a second groove between the third wall and the second wall;
a fourth wall surrounding the third wall, with a third groove between the fourth wall and the third wall; and
a plurality of ribs connecting the first wall and the second wall.

2. The multiple feed antenna of claim 1, wherein the third wall comprises at lease one non-circular groove between the second upper aperture and the third groove.

3. The multiple feed antenna of claim 1, wherein the third wall comprises at lease one arc-shaped groove between the second upper aperture and the third groove.

4. The multiple feed antenna of claim 1, further comprising a first plate disposed in a first bottom aperture of the first waveguide.

5. The multiple feed antenna of claim 4, wherein the first plate has a multi-step shape.

6. The multiple feed antenna of claim 1, further comprising a second plate disposed in a second bottom aperture of the second waveguide.

7. The multiple feed antenna of claim 6, wherein the second plate has a multi-step shape.

8. The multiple feed antenna of claim 1, further comprising a first plate disposed in a first bottom aperture of the first waveguide, a second plate disposed in a second bottom aperture of the second waveguide, and the first plate and the second plate are disposed in a perpendicular manner.

9. The multiple feed antenna of claim 8, wherein the first plate and the second plate have a multi-step shape.

10. The multiple feed antenna of claim 1, comprising four ribs separated by 90°.

11. The multiple feed antenna of claim 1, comprising four ribs disposed at 45° relative to a horizontal line.

12. The multiple feed antenna of claim 1, wherein the ribs have a tapered shape with an inner curve and an outer curve.

13. The multiple feed antenna of claim 1, wherein the ribs have a width substantially of 4°.

14. The multiple feed antenna of claim 1, wherein the third groove has a first depth around the first upper aperture, a second depth around the second upper aperture, and the first depth is smaller than the second depth.

15. The multiple feed antenna of claim 1, comprising at least two first waveguides, and the second waveguide being disposed between the at least two first waveguides.
